(19) United States
(12) Patent Application Publication
(10) Pub. No.: US 2007/0284512 A1
(43) Pub. Date: Dec. 13, 2007

(54) External force detecting device

(76) Inventors: Sawa Tanabe, Nagano-ken (JP); Atsushi Kitamura, Nagano-ken (JP); Shinya Suzuki, Nagano-ken (JP)

Correspondence Address: MCDERMOTT, WILL & EMERY LLP, 227 WEST MONROE STREET, SUITE 4400, CHICAGO, IL, 60606-5096, US

(21) Appl. No.: 11/714,626

(22) Filed: Mar. 6, 2007

(30) Foreign Application Priority Data
Mar. 7, 2006 (JP) 2006-061530

(51) Int. Cl. G01J 1/42

(52) U.S. Cl. 250/208.6

(57) ABSTRACT

In an external force detecting device including a support section and an action section disposed inside the support section, three optical displacement sensors are provided at an equiangular distance of 120 degrees about the rotational symmetry axis of the support section and each include a light source disposed at either the support section or the action section, and a light receiving element disposed at one section of the support section and the action section, the one section not provided with the light source, and the action section is located between the light source and the light receiving element. The external force detecting device described above enables an easy mounting of constituent members and a high resolution measurement, even when the diameter of the device is reduced.

### CROSS-REFERENCE TO RELATED APPLICATIONS

This application claims priority from Japanese Patent Application No. 2006-061530, filed Mar. 7, 2006.

### FEDERALLY SPONSORED RESEARCH OR DEVELOPMENT

Not applicable.

### TECHNICAL FIELD

The present invention relates to an external force detecting device, and more particularly to an external force detecting device which includes an action section to receive an external force and a support section to support the action section, and which detects an external force applied to the action section based on an output from an optical displacement sensor adapted to sense displacement in relative position between the action section and the support section by an amount of shift in light receiving position.

### BACKGROUND OF THE INVENTION

An external force detecting device, such as a six axis optical force sensor, is conventionally known, in which an amount of displacement of an action section relative to a support section is detected by an optical displacement sensor, and an external force applied to the action section is calculated according to an output signal from the optical displacement sensor.

For example, a six axis optical force sensor includes optical displacement sensors to measure six axis directional displacement, based on which a six axis force is calculated. Such a six axis optical force sensor includes three optical displacement sensors, each of which is basically composed of an optical sensor unit and is capable of measuring displacement with respect to two directions (X and Y directions), thus enabling measurement of six axis directional displacement. The optical sensor unit includes a light emitting diode (LED) as a light source and a photo diode (PD) assembly as a light receiving element such that the LED opposes the PD assembly with their respective optical central axes aligned to each other. The PD assembly is composed of four PDs and receives light emitted from the LED at its center area equally shared by the four PDs, whereby displacement of light receiving position at the PD assembly, that is to say relative positional displacement between a component attached to the LED and a component attached to the PD assembly, can be detected in the optical displacement sensor. In such a six axis optical force sensor, a six axis force applied between the component attached to the LED and the component attached to the PD assembly is calculated according to an output signal from each of the optical displacement sensors.

FIG. 14 is a top plan view of a conventional six axis force sensor disclosed in Japanese Patent Application Laid-Open No. H3-245028, and FIG. 15 is a cross sectional view of the six axis force sensor of FIG. 14 seen in direction XV. Referring to FIGS. 14 and 15, a six axis force sensor 1001 is basically structured with an elastic frame 1005 which integrally includes a support section 1002 shaped in a hollow circular-cylinder, an action section 1003 disposed centrally inside the support section 1002, and three elastic spoke members 1004 to bridge the support section 1002 and the action section 1003.

Three optical sensors 1008 are provided at the action section 1003 at an equiangular distance of 120 degrees, and three light sources 1009 are provided at the support section 1002 so as to oppose respective optical sensors 1008. A sensor unit 1010 is constituted by each of the optical sensors 1008 and the light sources 1009.

A six axis force sensor, that is an external force detecting device, utilizing a conventional optical displacement sensor as described above involves the following problem. The six axis force sensor disclosed in the aforementioned Japanese Patent Application Laid-Open No. H03-245028 is structured such that the optical sensor 1008 is provided at a portion of the action section 1003 positioned close to the light source 1009. In such a structure, if the outer diameter of the six axis sensor is decreased, the space for providing the light source and the optical sensor is limited making it difficult to mount constituent components and also difficult to secure a sufficient distance (optical path length) between the light source and the optical sensor (light receiving element) thus possibly failing to achieve precise displacement detection. This causes difficulty in downsizing further.

The distance (optical path length) between the light source and the light receiving element must be duly secured for the following reason. Generally, when the outer diameter of a six axis force sensor is decreased, the maximum displacement amount to be measured tends to become smaller. In such a case, the measurement resolution (sensitivity) must be enhanced, which requires reduction of the beam diameter of a light ray falling incident on an optical sensor, specifically a light receiving element. When a divergent light coming from the light source is turned into a light with a smaller beam diameter by using a normal lens, the distance between the light source and the lens is to be increased usually. Thus, for reducing the outer diameter of a six axis force sensor for the purpose of downsizing, a sufficient distance (optical path length) must be secured between the light source and the light receiving element.

### SUMMARY OF THE INVENTION

The present invention has been made in light of the circumstances described above, and it is an object of the present invention to provide an external force detecting device which allows an easy mounting of constituent components even when its outer diameter is small, and which enables a measurement with a high resolution performance.

In order to achieve the object described above, according to an aspect of the present invention, there is provided an external force detecting device which includes: a first section; a second section disposed internally of the first section at the center of the rotational symmetry axis thereof; elastic spoke members to bridge the first and second sections; and three optical displacement sensors arranged at an equiangular distance of 120 degrees about the rotational symmetry axis and each including: a light source disposed at one of the first and second sections; and a light receiving element disposed at the other one of the first and second sections. In the external force detecting device described above, the second section is located between the light source and the light receiving element, and an external force applied to one section of the first and second sections is calculated according to signals outputted respectively from the three optical displacement sensors which detect displacement of the one section receiving the external force relative to the other section.

In the aspect of the present invention, the spoke members may be arranged at an equiangular distance of 120 degrees about the rotational symmetry axis, and the three optical displacement sensors may be arranged such that the optical axes of the light sources are clear of the spoke members when viewed in the direction along the rotational symmetry axis.

In the aspect of the present invention, the light source may be constituted by an optical fiber.

According to the present invention, the external force detecting device allows an easy mounting of constituent members and enables a high resolution measurement, even when the outer diameter of the device is reduced.

Specifically, since one of the two sections of the device is located between the light source and the light receiving element constituting the optical displacement sensor so as to increase the optical path length between the light source and the light receiving element, the space for accommodating the light source can be secured thus making it easy to mount constituent members and enabling a high resolution measurement, while the diameter of the device is downsized.

Also, since the optical displacement sensor is structured such that the optical axes of the light sources are clear of the spoke members, the light source can be disposed at a radially outward position so as to increase the optical path length between the light source and the light receiving element, the space for accommodating the light source can be secured thus making it easy to mount constituent members and enabling a high resolution measurement, while the diameter of the device is downsized.

And, since the light source is constituted by an optical fiber, the space for accommodating the light source can be better secured thus making it still easier to mount constituent members and enabling a still higher resolution measurement, while the diameter of the device is downsized.

### BRIEF DESCRIPTION OF THE DRAWINGS

FIG. 1 is a perspective view of a six axis force sensor according to a first embodiment of the present invention;

FIG. 2 is a perspective view of the six axis force sensor of FIG. 1, removing its upper and lower lids;

FIG. 3 is a top plan view of FIG. 2;

FIG. 4 is a cross sectional view of FIG. 2 seen in direction in IV indicated in FIG. 3;

FIG. 5 is a perspective view of a six axis force sensor according to a second embodiment of the present invention (with its upper and lower lids omitted);

FIG. 6 is a top plan view of FIG. 5;

FIG. 7 is a cross sectional view of FIG. 5 seen in direction VII indicated in FIG. 6;

FIG. 8 is a perspective view of a six axis force sensor according to a third embodiment of the present invention (with its upper and lower lids omitted);

FIG. 9 is a top plan view of FIG. 8;

FIG. 10 is a cross sectional view of FIG. 8 seen in direction X indicated in FIG. 9;

FIG. 11 is a perspective view of a six axis force sensor according to a fourth embodiment of the present invention (with its upper and lower lids omitted);

FIG. 12 is a top plan view of FIG. 11;

FIG. 13 is a cross sectional view of FIG. 11 seen in direction XIII indicated in FIG. 12;

FIG. 14 is a top plan view of a conventional six axis force sensor (with its upper and lower lids omitted); and

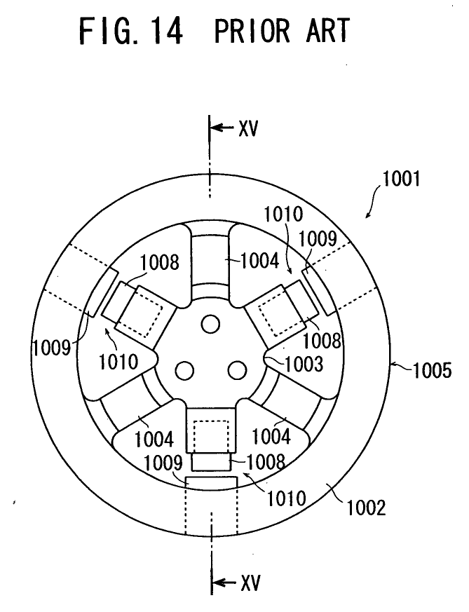

FIG. 15 is a cross sectional view of FIG. 14 (complete with its upper and lower lids) seen in direction XV.

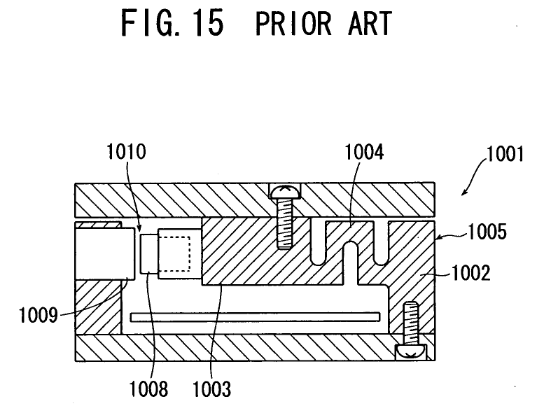

### DETAILED DESCRIPTION

Exemplary embodiments of the present invention will be described with reference to the accompanying drawings.

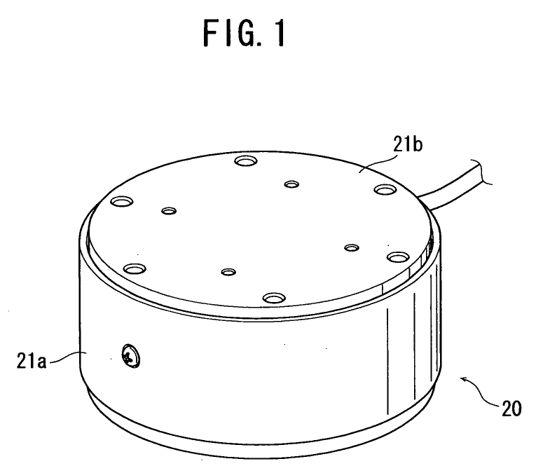

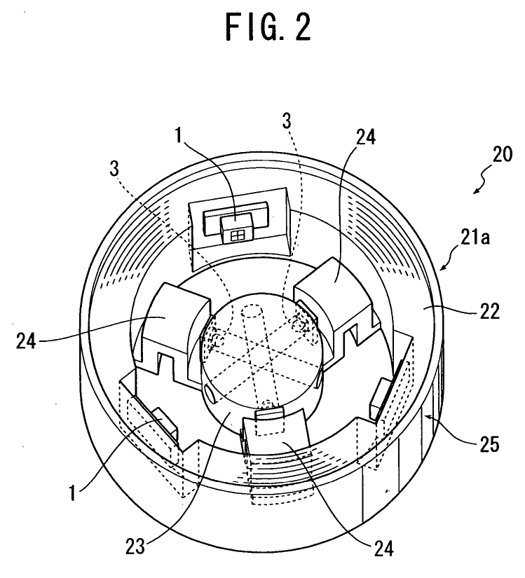

A first embodiment of the present invention will be described with reference to FIGS. 1 to 4. Referring to FIG. 1, a six axis force sensor 20 according to the first embodiment is shaped into a circular cylinder and externally structured with a main body 21a provided with an upper lid 21b and a lower lid (only partly seen and unnumbered). Referring to FIGS. 2, 3 and 4, the main body 21a of the six axis force sensor 20 is basically composed of a frame 25 which integrally includes a support section 22 shaped into a circular cylinder, an action section 23 disposed centrally inside the support section 22, and three elastic spoke members 24 to bridge the support section 22 and the action section 23.

In the present embodiment, the cylinder wall portion constitutes the support section 22, and the center portion constitutes the action section 23, but the present invention is not limited to this arrangement and may be arranged such that the cylinder wall portion constitutes an action section while the center portion constitutes a support section.

The frame 25 is made of aluminum alloy formed by cutting work and electric spark machining. The spoke members 24 are structured in a crooked shape so as to be elastically deformable with respect to all the directions. The support section 22 and the action section 23 are attached to both of two objects to which a force to be measured is applied, whereby when the force applied acts on the six axis force sensor 20, micro-displacement in and micro-rotation about three axis direction are caused between the support section 22 and the action section 23.

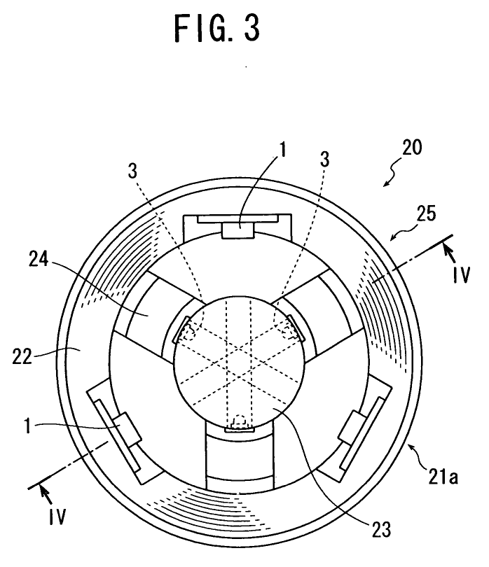

Referring to FIGS. 2, and 3, three optical sensors (light receiving elements, such as PDs) 1 are disposed at the support section 22 at an equiangular distance of 120 degrees, and three light sources (for example, LED) 3 are disposed respectively at portions of the action section 23 corresponding to the spoke members 24 at an equiangular distance of 120 degrees so as to face toward respective three optical sensors 1 so that respective lights emitted from the light sources 3 pass the rotational symmetry center of the action section 23 and impinge on the optical sensors 1. Light emitted from the light source 3 and passing the action section 23 is adapted to fall incident on the optical sensor 1 at the center of its light receiving face, whereby the optical sensor 1 can detect and calculate displacement of the action section 23 relative to the support section 22 with respect to two axis directions orthogonal to the optical axis center of the light.

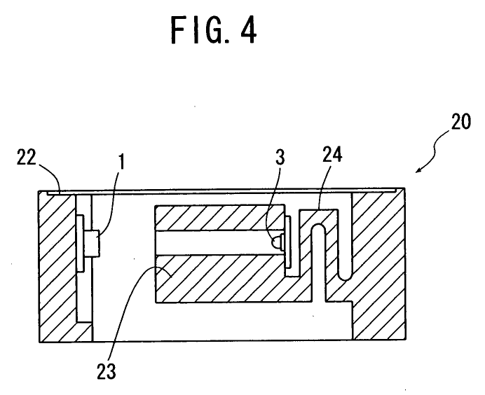

In the present embodiment, the action section 23 defines some height dimension (thickness), and throughholes for passing the lights from the light sources 3 to the optical sensors 1 are formed in the action section 23 as shown in FIG. 4. The present invention is not limited to this optical path structure, and the throughholes may be replaced by grooves, or alternatively the thickness of the action section 23 may be reduced for duly passing the lights insofar as the action section 23 provides a mechanical strength required and specified. Also, the action section 23 is structured as one segment in the present embodiment, but may alternatively be divided into two segments with respect to its thickness thus providing upper (top) and lower (base) segments, whereby optical members such as light sources can be previously attached to the top segment off the base segment, and then the top segment with the light sources is mounted on the base segment thus enabling an easier attachment of the optical members to the action section 23.

According to the first embodiment described above, the optical path length between the light source 3 and the optical sensor 1 is increased by the length of the throughhole formed in the action section 23 compared with the traditional six axis force sensor.

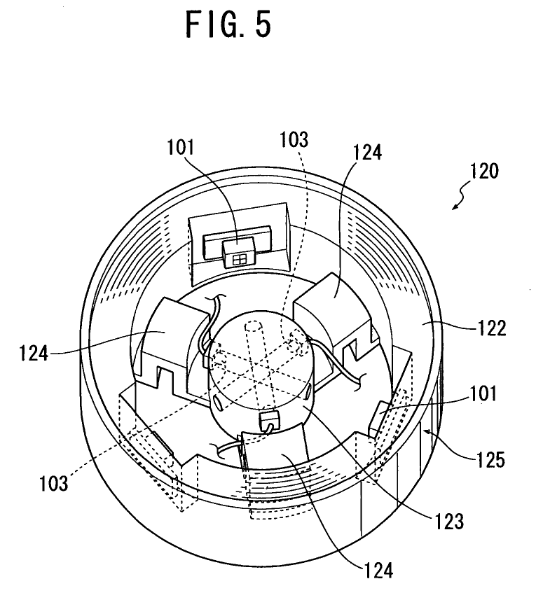

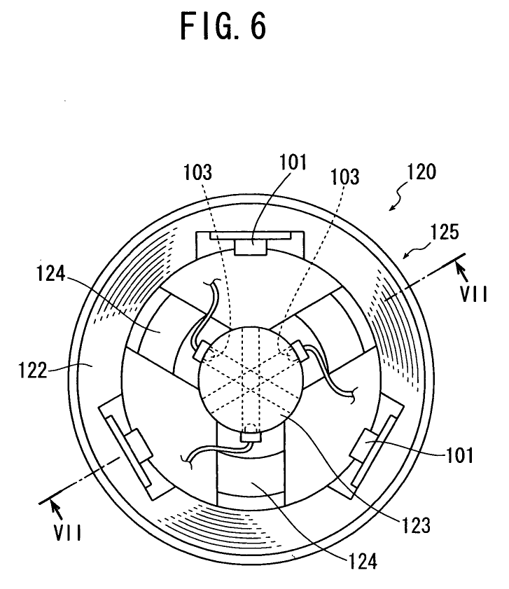

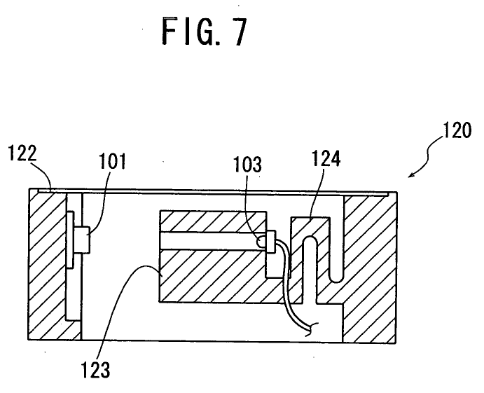

A second embodiment of the present invention will be described with reference to FIGS. 5, 6 and 7. Referring to FIGS. 5 to 7, a six axis force sensor 120 according to the second embodiment has a substantially same frame structure as the six axis force sensor 20 according to the first embodiment, specifically the six axis force sensor 20 is structured with a frame 125 which is made of aluminum alloy formed by cutting work and electric spark machining and which integrally includes a support section 122 shaped into a circular cylinder, an action section 123 disposed centrally inside the support section 122 and having three throughholes passing the center thereof, and three elastic spoke members 124 structured in a crooked shape so as to be elastically deformable with respect to all the directions and adapted to bridge the support section 122 and the action section 123.

In the present embodiment, the cylinder wall portion constitutes the support section 122, and the center portion constitutes the action section 123, but the present invention is not limited to this arrangement and may be arranged such that the cylinder wall portion constitutes an action section while the center portion constitutes a support section.

The support section 122 and the action section 123 are attached to both of two objects to which a force to be measured is applied, whereby when the force applied acts on the six axis force sensor 120, micro-displacement in and micro-rotation about three axis direction are caused between the support section 122 and the action section 123.

The six axis force sensor 120 includes three optical sensors (light receiving elements, such as PDs) 101 disposed at the support section 122 in the same arrangement as the optical sensors 1 of the six axis force sensor 20 according to the first embodiment, but differs from the six axis force sensor 20 in that the action section 123 is provided with three light outlet ends 103 of optical fibers in place of the three light sources 3. The three light outlet ends 103 of optical fibers are disposed respectively at portions of the action section 123 corresponding to the spoke members 123 at an equiangular distance of 120 degrees so as to face toward respective three optical sensors 101. In the arrangement described above, respective lights exiting from the light outlet ends 103 of optical fibers pass the rotational symmetry center of the action section 123 and impinge on the optical sensors 101.

In the second embodiment, three discrete optical fibers may be used together with three light sources (for example LEDs, not shown) disposed respectively at three light inlet ends (not shown) of the discrete optical fibers, or alternatively one optical fiber that branches off so as to provide three light outlet ends while having one light inlet end (not shown) may be used together with only one light source (not shown) disposed at the light inlet end (not shown) of the branching optical fiber. In any of the arrangements described above, each light emitted from the light outlet end 103 of an optical fiber and passing the action section 123 is adapted to fall incident on the optical sensor 101 at the center of its light receiving face, whereby the optical sensor 101 can detect and calculate displacement of the action section 123 relative to the support section 122 with respect to two axis directions orthogonal to the optical axis center of the light.

The optical path may be achieved by means of throughholes or grooves formed in the action section 123, or by reducing the thickness of the action section 123 in the same way as described in the first embodiment. Also, the action section 123 may be divided into two segments for enabling an easier attachment of optical members to the action section 123 in the same way as described in the first embodiment.

The second embodiment described above achieves the same advantage as the first embodiment in increasing the optical path length between the light outlet end 103 of an optical fiber (corresponding to the light source 3) and the optical sensor 101 by the length of the throughhole formed in the action section 123, and another advantage in that the light outlet end 103 of an optical fiber occupies a smaller space than the light source 3 thus enabling downsizing of the device, and that the number of light sources may be reduced.

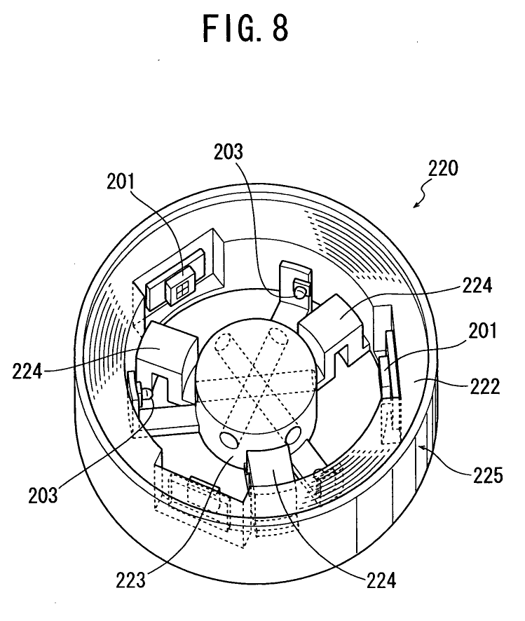

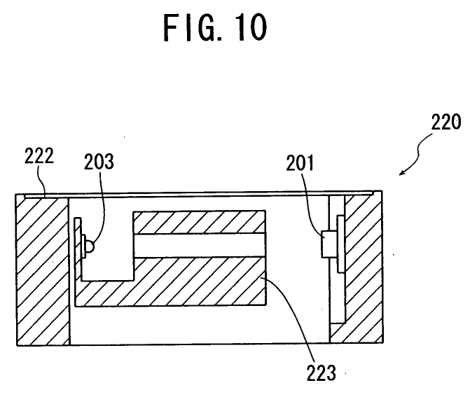

A third embodiment of the present invention will be described with reference to FIGS. 8, 9 and 10. Referring to FIGS. 8 to 10, a six axis force sensor 220 according to the third embodiment has a frame structure basically same as that of the six axis force sensor 20 according to the first embodiment, specifically is structured with a frame 225 which is made of aluminum alloy formed by cutting work and electric spark machining and which integrally includes a support section 222 shaped into a circular cylinder, an action section 223 disposed centrally inside the support section 222 and having three throughholes passing the center thereof, and three elastic spoke members 224 structured in a crooked shape so as to be elastically deformable with respect to all the directions and adapted to bridge the support section 222 and the action section 223.

In the present embodiment, the cylinder wall portion constitutes the support section 222, and the center portion constitutes the action section 223, but the present invention is not limited to this arrangement and may be arranged such that the cylinder wall portion constitutes an action section while the center portion constitutes a support section.

The support section 222 and the action section 223 are attached to both of two objects to which a force to be measured is applied, whereby when the force applied acts on the six axis force sensor 220, micro-displacement in and micro-rotation about three axis direction are caused between the support section 222 and the action section 223.

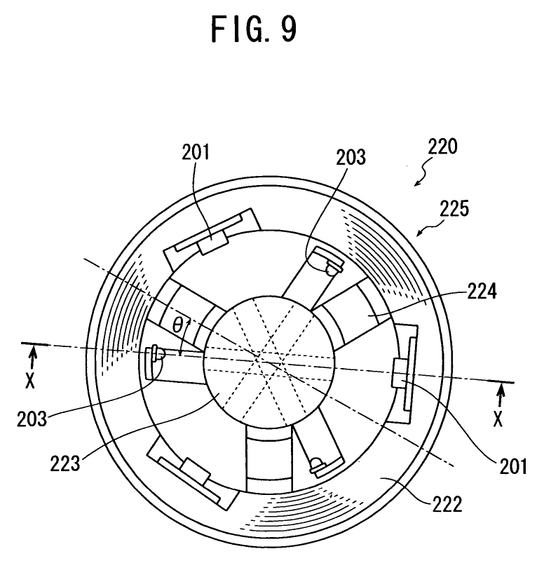

The six axis force sensor 220 includes three optical sensors (light receiving elements, such as PDs) 201 disposed at the support section 222 in the same arrangement as the optical sensors 1 of the six axis force sensor 20 according to the first embodiment, but differs from the six force sensor 20 in that three light sources (for example, LEDs) 203 are disposed at portions of the action section 223 shifted in the rotational direction from the spoke members 224, rather than at portions of the action section 223 corresponding to the spoke members 224, so that the optical axis of the light from the light source 203 makes an angle of θ with respect to the radial direction line of the spoke member 224 (see FIG. 9) thus making the light source 203 clear of the spoke member 224, which allows the light sources 203 to be located farther from the center of the action section 223 thus further increasing the optical path length between the light source and the optical sensor compared with the six axis force sensor 20.

In the arrangement described above, respective lights exiting from the light sources 203 of optical fibers pass the rotational symmetry center of the action section 223 and each impinge on the optical sensor 201 at the center of its light receiving face, whereby the optical sensor 201 can detect and calculate displacement of the action section 223 relative to the support section 222 with respect to two axis directions orthogonal to the optical axis center of the light.

The optical path may be achieved by means of throughholes or grooves formed in the action section 223, or by reducing the thickness of the action section 223 in the same way as described in the first embodiment. Also, the action section 223 may be divided into two segments for enabling an easier attachment of optical members to the action section 223 in the same way as described in the first embodiment. In the embodiment shown in FIGS. 8 to 10, the light sources 203 are disposed on members extending radially outwardly from the action section 223, but the present invention is not limited to this structure and the light sources 203 may be attached directly to the action section 223.

According to the third embodiment described above, the optical path length between the light source 203 and the optical sensor 201 is increased by the length of the throughhole formed in the action section 223 compared with the traditional six axis force sensor, and further increased by the length of the member extending out from the action section 223 compared with the six axis force sensor 20 according to the first embodiment.

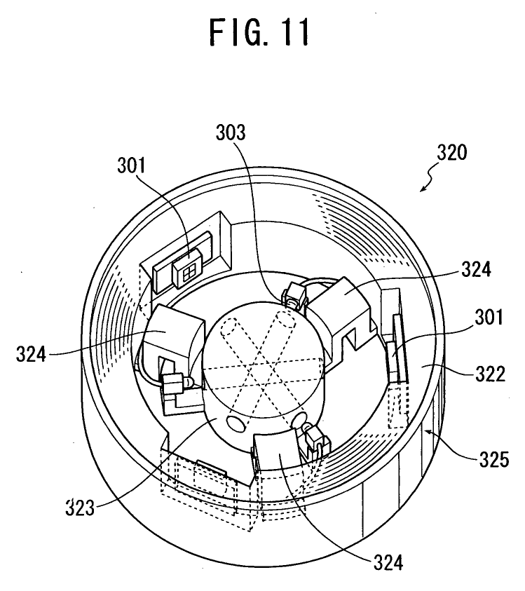

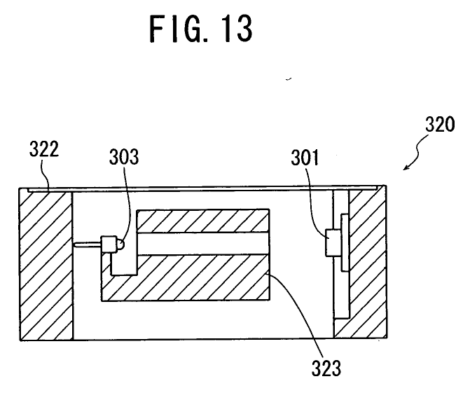

A fourth embodiment of the present invention will be described with reference to FIGS. 11, 12 and 13. Referring to FIGS. 11 to 13, a six axis force sensor 320 according to the third embodiment has a substantially same frame structure as the six axis force sensor 220 according to the third embodiment, specifically is structured with a frame 325 which is made of aluminum alloy formed by cutting work and electric spark machining and which integrally includes a support section 322 shaped into a circular cylinder, an action section 323 disposed centrally inside the support section 322 and having three throughholes passing the center thereof, and three elastic spoke members 324 structured in a crooked shape so as to be elastically deformable with respect to all the directions and adapted to bridge the support section 322 and the action section 323.

In the present embodiment, the cylinder wall portion constitutes the support section 322, and the center portion constitutes the action section 323, but the present invention is not limited to this arrangement and may be arranged such that the cylinder wall portion constitutes an action section while the center portion constitutes a support section.

The support section 322 and the action section 323 are attached to both of two objects to which a force to be measured is applied, whereby when the force applied acts on the six axis force sensor 320, micro-displacement in and micro-rotation about three axis direction are caused between the support section 322 and the action section 323.

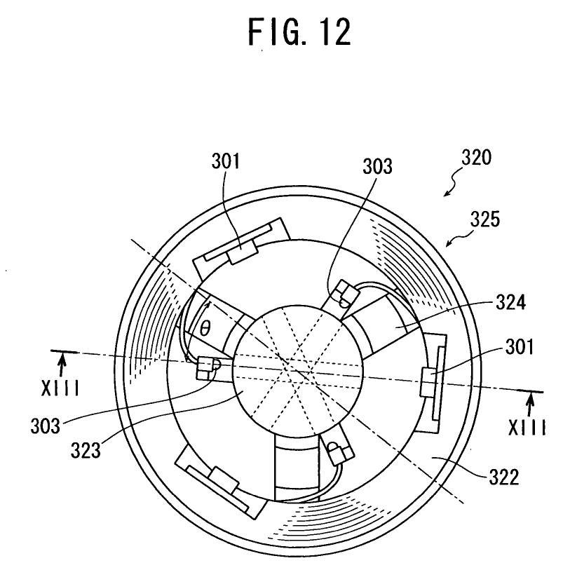

The six axis force sensor 320 includes three optical sensors (light receiving elements, such as PDs) 301 disposed at the support section 322 in the same arrangement as the optical sensors 301 of the six axis force sensor 220 according to the third embodiment, but differs from the six axis force sensor 220 in that the action section 322 is provided with three light outlet ends 303 of optical fibers in place of the three light sources 203. The three light outlet ends 303 of optical fibers are disposed at portions of the action section 323 shifted in the rotational direction from the spoke members 324, rather than at portions of the action section 323 corresponding to the spoke members 324, so that the optical axis of the light from the light outlet end 303 makes an angle of θ with respect to the radial direction line of the spoke member 324 (see FIG. 12) thus making the light outlet end 303 clear of the spoke member 324, which allows the light outlet ends 303 to be located farther from the center of the action section 323 thus further increasing the optical path length between the light outlet end of an optical fiber and the optical sensor compared with the six axis force sensor 120 according to the second embodiment.

In the arrangement described above, respective lights exiting from the light outlet ends 303 of optical fibers pass the rotational symmetry center of the action section 323 and impinge on the optical sensors 301.

In the fourth embodiment, three discrete optical fibers may be used together with three light sources (for example LEDs, not shown) disposed respectively at three light inlet ends (not shown) of the discrete optical fibers, or alternatively one optical fiber that branches off so as to be provided with three light outlet ends while having one light inlet end (not shown) may be used together with only one light source (not shown) disposed at the light inlet end (not shown) of the branching optical fiber. In any of the arrangements described above, each light emitted from the light outlet end 303 and passing the action section 123 is adapted to fall incident on the optical sensor 301 at the center of its light receiving face, whereby the optical sensor 301 can detect and calculate displacement of the action section 123 relative to the support section 322 with respect to two axis directions orthogonal to the optical axis center of the light.

The optical path may be achieved by means of throughholes or grooves formed in the action section 323, or by reducing the thickness of the action section 323 in the same way as described in the first embodiment. Also, the action section 323 may be divided into two segments for enabling an easier attachment of optical members to the action section 323 in the same way as described in the first embodiment.

The fourth embodiment described above enjoys both of the advantages achieved by the second and third embodiments over the first embodiment, specifically, enables further increase of the optical path length while achieving reduction of the accommodating space for the light emitting member thus enabling further and easier downsizing of the device, and at the same time provides another advantage that the optical fiber can be arranged radially behind the crooked portion of the spoke member 324 and therefore can be bent with an increased curvature compared with the second embodiment thus reducing the bending loss.

While the present invention has been illustrated and explained with respect to specific embodiments thereof, it is to be understood that the present invention is by no means limited thereto but encompasses all changes and modifications that will become possible within the scope of the appended claims.

What is claimed is:

1. An external force detecting device comprising:
a first section;
a second section disposed internally of the first section at a center of a rotational symmetry axis thereof;
elastic spoke members to bridge the first and second sections; and
three optical displacement sensors arranged at an equiangular distance of 120 degrees about the rotational symmetry axis, each of the sensors comprising: a light source disposed at one of the first and second sections; and a light receiving element disposed at the other one of the first and second sections, wherein the second section is located between the light source and the light receiving element, and wherein an external force applied to one section of the first and second sections is calculated according to signals outputted respectively from the three optical displacement sensors which detect displacement of the one section receiving the external force relative to the other section.

2. An external force detecting device according to claim 1, wherein the spoke members are arranged at an equiangular distance of 120 degrees about the rotational symmetry axis, and wherein the three optical displacement sensors are arranged such that optical axes of the light sources are clear of the spoke members when viewed in a direction along the rotational symmetry axis.

3. An external force detecting device according to claim 1, wherein the light source is constituted by an optical fiber.

4. An external force detecting device according to claim 2, wherein the light source is constituted by an optical fiber.
